(19) United States
(12) Patent Application Publication
(10) Pub. No.: US 2012/0049675 A1
(43) Pub. Date: Mar. 1, 2012

(54) ELECTRIC POWER GENERATING DIFFERENTIAL

(75) Inventors: FRANK JAMES VARGO, Crofton, MD (US); Gregory L. Heatwole, Marshall, MI (US)

(73) Assignee: Eaton Corporation, Cleveland, OH (US)

(21) Appl. No.: 12/870,230

(22) Filed: Aug. 27, 2010

(51) Int. Cl. H02K 7/116; F16H 48/00

(52) U.S. Cl. 310/83; 475/150; 903/951

(57) ABSTRACT

A differential comprises a differential case and electrical generator. The electrical generator comprises a first portion that is supported by the differential case and a second portion that is disposed in the differential case. The electrical generator is responsive to rotation of the differential case for generating electrical power. In another embodiment, the differential may further comprise a differential gear set, and the electrical generator comprises a first portion that is supported by the differential gear set and a second portion that is disposed in the differential case in accordance with an embodiment of the invention. The electrical generator is responsive to movement of the differential gear set for generating electrical power. In another embodiment, an axle assembly includes a differential case and axle housing that together function as an electrical generator. The rotation of the differential case generates electrical power.

### TECHNICAL FIELD

The present invention relates to a differential, including a differential configured to generate electrical power.

### BACKGROUND

Motor vehicle manufacturers are actively working to develop alternative powertrain systems in an effort to reduce the level of pollutants exhausted into the air by conventional powertrains equipped with internal combustion engines, as well as to address the high cost of fuel. Significant development efforts have been directed to electric vehicles, fuel-cell vehicles, and “hybrid” vehicles. Hybrid vehicles are equipped with an internal combustion engine and an electric motor that can be operated independently or in combination with the internal combustion engine to provide motive power to the vehicle and offer a compromise between traditional internal combustion engine powered vehicles and full electric powered vehicles.

As motor vehicle manufacturers shift design considerations from internal combustion engines or standard gasoline motors to electric motors, the need to address recharging the motor vehicle's electric power supply becomes increasingly critical. It may be desirable to generate electrical power from existing motor vehicle components and/or systems. The ability to generate electrical power from the differential, for example, may allow a motor vehicle to recharge its electrical power supply without requiring a significant increase in the number of parts, components, or systems in a motor vehicle.

### SUMMARY

A differential comprising a differential case and electrical generator is provided. The electrical generator may comprise a first portion that is supported by the differential case and a second portion that is disposed in the differential case in accordance with an embodiment of the invention. The electrical generator may be responsive to rotation of the differential case for generating electrical power.

A differential comprising a differential case, a differential gear set, and an electrical generator is provided. The differential gear set may be disposed within the differential case. The electrical generator may comprise a first portion that is supported by the differential gear set and a second portion that is disposed in the differential case in accordance with an embodiment of the invention. The electrical generator may be responsive to movement of the differential gear set for generating electrical power.

An axle assembly comprising an axle housing, a differential, and an electrical generator is provided. The differential may comprise a differential case. The electrical generator may include a first portion that comprises the differential case and a second portion that comprises the axle housing in accordance with an embodiment of the invention. The electrical generator may be responsive to rotation of the differential case for generating electrical power.

### BRIEF DESCRIPTION OF THE DRAWINGS

Embodiments of the invention will now be described, by way of example, with reference to the accompanying drawings, wherein:

FIG. 1 is a schematic view of an axle assembly including an electric power generating differential in accordance with an embodiment of the invention.

FIG. 2 is a schematic view of an axle assembly including an electric power generating differential in accordance with an embodiment of the invention.

FIG. 3 is a schematic view of an axle assembly including an electric power generating differential in accordance with an embodiment of the invention.

FIG. 4 is a schematic view of an axle assembly including an electric power generating differential in accordance with an embodiment of the invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as embodied by the appended claims.

Powertrain systems may be used for generating power from a source and transferring such power from the source to a driven mechanism. In a typical configuration, power may generated by an engine, may be converted into torque, and may then be “transmitted” through a transmission to a drive shaft. The use of a drive pinion gear and ring gear may be configured to transfer the torque from the drive shaft to the drive axle, as the drive axle is perpendicular to the drive shaft. The drive pinion gear may receive input drive torque from the vehicle driveline. When the teeth of the drive pinion gear engage the ring gear, the ring gear may be configured to turn perpendicular to the drive shaft. The drive axle may be attached to the ring gear through an axle housing and differential. In particular, the ring gear may be attached to the differential by any means conventional in the art, including, but not limited to a plurality of bolts.

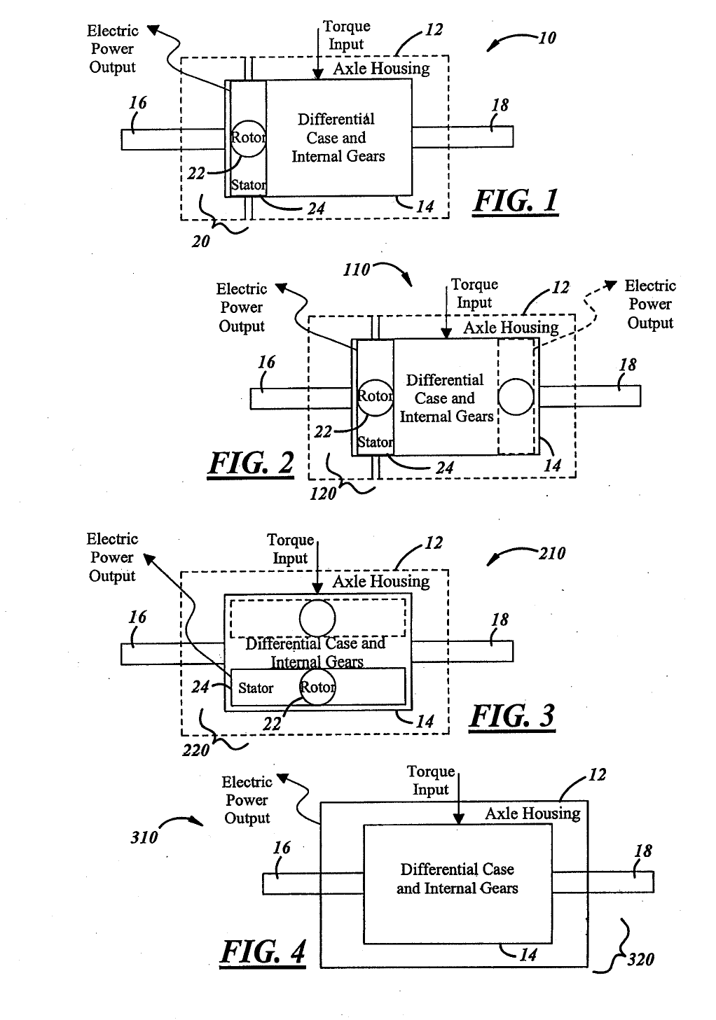

Referring now to FIGS. 1-4, an axle assembly 10, 110, 210, 310 comprising axle housing 12 and differential 14 in accordance with various embodiments of the invention are schematically illustrated. Axle housing 12 may comprise a protective non-rotatable housing in connection with an embodiment of the invention. The axle housing 12 may enclose and/or include a central carrier which rotatably supports differential 14. The central carrier may have a pair of outwardly extending tubes which may be configured to enclose the axle shafts 16, 18 extending from the differential 14 to the wheels of the motor vehicle employing the axle assembly 10, 110, 210, 310 in an embodiment of the invention. In other embodiments of the invention, the axle housing 12 may include a central carrier without a pair of outwardly extending tubes, and the central carrier may be configured to enclose the axle shafts 16, 18 extending from the differential 14 to the wheels of the motor vehicle employing the axle assembly 10, 110, 210, 310. Such an axle housing (i.e., without outwardly extending tubes) may comprise, for example and without limitation, an independent axle housing. Although these two axle housings are mentioned in detail, any number of various axle housings may be used in connection with the inventive axle assembly 10, 110, 210, 310. The inventive axle assembly 10, 110, 210, 310 may be used in connection with the front and/or rear axle of a motor vehicle. The rotation of the differential 14 may be caused by the drive shaft in a manner that is well known in the art. Rotation of the differential 14 may thus cause corresponding rotation of the output axle shafts. The differential 14 may be configured to distribute torque from the input drive shaft to the two output axle shafts 16, 18, while permitting such output axle shafts 16, 18 to rotate at different speeds under certain conditions. For example, torque may be supplied to both wheels of the vehicle as the motor vehicle negotiates a turn, which may permit the outside wheel to turn faster than the inside wheel.

Still referring to FIGS. 1-4, schematic views of axle assembly 10, 110, 210, 310 including a differential 14 in accordance with various embodiments of the invention are generally illustrated. The differential 14 may be substantially identical to any differential that is conventional in the art, except for the inclusion of an electrical generator as described herein in accordance with various embodiments. Accordingly, the scope of this invention is not intended to be limited for use with any specific differential. On the contrary, the inventive differential 14 may comprise a standard open differential design, a limited slip differential design, and/or a locking differential design depending on the desired functionality of the differential.

Differential 14 may comprise a differential case. The differential case may include a first end (e.g., a flange end) and a second opposing end (e.g., a bell end) in accordance with an embodiment of the invention. The differential case may be configured to define a gear chamber and house a gear set and various other components of differential 14. The gear set may comprise a plurality (e.g., two) of side gears and a plurality (e.g., two) of pinion gears. The pinion gears may be rotatably supported on a pinion shaft that may be connected to the differential case by various means conventional in the art. The pinion gears may be in meshing engagement with the side gears. The side gears may each include an annular hub portion that is configured to receive an axle shaft of a motor vehicle.

The differential case of differential 14 may be configured for rotation, and the rotation of the differential case may be used to generate electric power in accordance with an embodiment of the invention. For example, the differential 14 may include an electrical generator 20, 120, 220, 320 (e.g., alternator design) for generating electricity to supply power to one or more electrical components (e.g., a battery or electric motor), rather than the differential itself. Although a battery and electric motor are described in detail, the electrical component may comprise any number of other electrical components as understood by those of ordinary skill in the art. The differential 14 may be configured so that only minimal oil may be introduced into the portion of the differential 14 comprising an electrical generator 20, 120, 220, 320.

The electrical generator 20, 120, 220, 320 may be responsive to rotation of the differential case for generating electrical power. In accordance with an embodiment of the invention, the electrical generator 20 may comprise a first portion 22 that is supported by the differential case of differential 14 and a second portion 24 that is disposed within the differential case of differential 14. The first portion 22 of the electrical generator 20 may be connected (e.g., attached) to the differential case in an embodiment of the invention. The first portion 22 of the electrical generator 20 may be integral with the differential case in an embodiment of the invention. The first portion 22 of the electrical generator 20 may, thus, be driven by the differential case during normal driving activities. The second portion 22 of the electrical generator 20 may be internal to the differential case and may be held stationary relative to the differential case and relative to the axle housing 12.

The first portion 22 of the electrical generator 20 may comprise a magnetic rotor, and the second portion 24 of the electrical generator 20 may comprise a stator in accordance with an embodiment of the invention. For example only, the magnetic rotor may comprise a plurality of permanent magnets that are configured in an annular array in connection with an embodiment of the invention. For another example only, the stator may comprise a plurality of windings of an electrical conductor (e.g., copper) surrounding a fixed iron core. The rotor may be configured to fit within the stator in accordance with an embodiment of the invention. For example and without limitation, when the magnets of the rotor are rotated past the permanent magnets of the stator, electrical current may be induced in the windings. Such induced electrical currents may be used to supply electrical power through one or more wires (not shown) to one or more vehicle components during operation of the motor vehicle employing the inventive differential 14. Although certain examples for the magnetic rotor and stator are described herein, the magnetic rotor and stator of the electrical generator 20 may be formed from any desired components that generate electrical power when rotated or otherwise moved relative to one another. The magnetic rotor and stator may be similar in design and functionality to an automotive alternator.

In an embodiment of the invention, the second portion 24 of the electrical generator 20 may comprise a plurality of stators. For example and without limitation, the second portion 24 of the electrical generator 20 may comprise two stators. A first stator may be disposed at a first end of the differential case (e.g., inside of the differential case) in an embodiment. For example, the first end of the differential case may be proximate axle shaft 16. A second stator may be disposed at a second end of the differential case (e.g., inside of the differential case) opposing the first end of the differential case in an embodiment. For example, the second end of the differential case may be proximate axle shaft 18.

Referring now to FIGS. 2-3, in accordance with an embodiment of the invention, the electrical generator 120, 220 may comprise a first portion 22 that is supported by the differential gear set within the differential case of differential 14. The differential gear set may comprise at least one pinion gear and at least one side gear as described herein. The electrical generator 120, 220 may further comprise a second portion 24 that is disposed within the differential case of differential 14. The first portion 22 of the electrical generator 120, 220 may be connected (e.g., attached) to the differential gear set in an embodiment of the invention. The first portion 22 of the electrical generator 120, 220 may be integral with the differential gear set in an embodiment of the invention. The first portion 22 of the electrical generator 120, 220 may, thus, be driven by the differential gear set during normal driving activities. Accordingly, the electrical generator 120, 220 may be responsive to movement of the differential gear set for generating electrical power. The second portion 22 of the electrical generator 120 may be internal to the differential case and may be held stationary relative to the differential case and relative to the axle housing 12.

The first portion 22 of the electrical generator 120, 220 may comprise a magnetic rotor, and the second portion 24 of the electrical generator 120, 220 may comprise a stator in accordance with an embodiment of the invention. The magnetic rotor and stator of the electrical generator 120, 220 may be formed from any desired components that generate electrical power when rotated or otherwise moved relative to one another.

In an embodiment of the invention, the second portion 24 of the electrical generator 120 may comprise a plurality of stators. For example and without limitation, the second portion 24 of the electrical generator 120, 220 may comprise two stators. A first stator may be disposed at a first end or side of the differential case (e.g., inside of the differential case) in an embodiment. A second stator may be disposed at a second end or side of the differential case (e.g., inside of the differential case) opposing the first end or side of the differential case in an embodiment. For example, the first end of the differential case may be proximate axle shaft 18 and the second end of the differential case may be proximate axle shaft 18, as generally illustrated in FIG. 2. For another example, the first end of the differential case may be located toward a first direction transverse to the drive axle and the second end of the differential case may be located toward a second opposing direction transverse to the drive axle, as generally illustrated in FIG. 3.

Referring now to FIG. 4, in accordance with an embodiment of the invention, the axle assembly 330 may include axle housing 12, a differential 14 comprising at least a differential case, and electrical generator 320. The electrical generator 320 may comprise a first portion that comprises the differential case of differential 14. In particular, the differential case may act as a magnetic rotor during normal driving activities. For example, the surface of the differential case may covered and/or coated in one or a plurality of magnets. For another example, the differential case itself may comprise a magnetic material (e.g., the differential case itself may function as a magnet). The electrical generator 320 may further comprise a second portion that comprises the axle housing 12. In particular, the axle housing 12 may act as a stator. The axle housing 12 may support coil windings (e.g., copper coil windings) comprising the stator). Accordingly, the electrical generator 320 may be responsive to rotation of the differential case for generating electrical power. Although the first portion and second portion of the electrical generator 320 are described as a magnetic rotor and stator, the electrical generator 320 may be formed from any desired components that generate electrical power when rotated or otherwise moved relative to one another.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed:

1. A differential, comprising:
a differential case; and
an electrical generator comprising:
a first portion that is supported by the differential case; and
a second portion that is disposed within the differential case,
the electrical generator being responsive to rotation of the differential case for generating electrical power.

2. The differential of claim 1, wherein the first portion of the electrical generator comprises a magnetic rotor.

3. The differential of claim 2, wherein the magnetic rotor comprises a plurality of permanent magnets that are configured in an annular array.

4. The differential of claim 2, wherein the magnetic rotor is connected to the differential case.

5. The differential of claim 2, wherein the magnetic rotor is integral to the differential case.

6. The differential of claim 1, wherein the second portion of the electrical generator comprises a stator.

7. The differential of claim 6, wherein the stator comprises a plurality of windings of an electrical conductor.

8. The differential of claim 6, wherein the stator is stationary relative to the differential case.

9. The differential of claim 1, wherein the second portion of the electrical generator comprises a plurality of stators, wherein a first of the plurality of stators is located proximate a first end of the differential case and a second of the plurality of stators is located proximate a second opposing end of the differential case.

10. A differential, comprising:
a differential case;
a differential gear set disposed within the differential case;
an electrical generator comprising:
a first portion that is supported by the differential gear set; and
a second portion that is disposed within the differential case,
the electrical generator being responsive to movement of the differential gear set for generating electrical power.

11. The differential of claim 1, wherein the different gear set comprises:
at least one pinion gear; and
at least one side gear.

12. The differential of claim 10, wherein the first portion of the electrical generator comprises a magnetic rotor.

13. The differential of claim 12, wherein the magnetic rotor is connected to the differential gear set.

14. The differential of claim 12, wherein the magnetic rotor is integral to the differential gear set.

15. An axle assembly, comprising:
an axle housing;
a differential comprising at least a differential case; and
an electrical generator, wherein a first portion of the electrical generator comprises the differential case and wherein a second portion of the electrical generator comprises the axle housing, the electrical generator being responsive to rotation of the differential case for generating electrical power.

16. The axle assembly of claim 15, wherein the first portion of the electrical generator is a magnetic rotor.

17. The axle assembly of claim 15, wherein the differential case comprises a magnetic material.

18. The axle assembly of claim 15, further comprising at least one magnet connected to the differential case.

19. The axle assembly of claim 15, wherein the second portion of the electrical generator is a stator.
